(19) United States
(12) Patent Application Publication
(10) Pub. No.: US 2002/0189104 A1
(43) Pub. Date: Dec. 19, 2002

(54) Stiles razor

(76) Inventor: Sharidan Lorraine Stiles, Sacramento, CA (US)

Correspondence Address: Richard A. Nebb, Esq., Dergosits & Noah LLP, Suite 1450, Four Embarcadero Center, San Francisco, CA, 94111, US

(21) Appl. No.: 10/219,095

(22) Filed: Aug. 13, 2002

Related U.S. Application Data
(63) Continuation of application No. 09/725,789, filed on Nov. 29, 2000.
(60) Provisional application No. 60/245,397, filed on Nov. 1, 2000.

(51) Int. Cl. B26B 21/22; B26B 21/52

(52) U.S. Cl. 30/50; 30/526

(57) ABSTRACT

A hand-held razor has single or multiple blades of a smaller dimension, e.g., one inch or less, embodied either as part of an integrated disposable razor or as part of a replaceable razor blade cartridge.

### SUMMARY OF THE INVENTION

The present invention is a hand-held razor having blades of a smaller dimension to facilitate personal grooming.

### BRIEF DESCRIPTION OF THE DRAWINGS

FIG. 1 is a front perspective view of a preferred razor embodiment.

FIG. 2 is a side perspective view of the razor of FIG. 1.

FIG. 3 is a top perspective view of the razor of FIG. 1.

FIG. 4 is a top perspective view of a portion of the razor of FIG. 1 taken across section A-A of FIG. 2.

FIG. 5 is a side perspective view of an alternative embodiment of the inventive razor having a replaceable blade portion

### DETAILED DESCRIPTION OF THE INVENTION

The present invention is a styling and grooming razor used for removing unwanted body hair in hard-to-reach or awkward places. For example, the razor could be used to groom the eyebrows, moustache, nose, sideburns, scalp, abdomen, bikini area, toes, etc. The invention is able to do these things because the size of the razor blades are very small in comparison to conventional razor blades. For example, the blades may preferably be 1 inch, ½ inch, ⅜ inch, ¼ inch, ⅛ inch or other small sizes. Further, each of the different size blades may be used as interchangeable cartridges on the same razor handle, and may have single or multiple cutting edges. Alternatively, the razor may be integrally molded of plastic, for example, to provide a number of different fixed blade widths in a disposable form.

Conventional hand-held razors are well known. For example, standard and disposable razors are marketed by Gillette, Schick and others. These companies sell two types of razors. The disposable razor includes a handle and angled head having a fixed blade (single or twin) as a single, integrally molded device. The disposable razor may be thrown away when the blade has become too dull for effective shaving. The standard razor includes a handle and angled head which includes some sort of retention mechanism for holding replaceable blade cartridges.

While both types of razors are extremely popular, the razor blades are fairly wide and are typically only effective for shaving facial hair or leg hair, for example. The present invention is a significant improvement in that a variety of narrower width blades can be provided to facilitate use of a razor for styling and grooming of smaller or more awkward areas of the body.

FIG. 1 shows a front view of the invention having a handle 10 and blade attachment portion 20. As shown in the side view of FIG. 2, the blade attachment portion 20 is part of an angular head portion 12 of the handle 10. Preferably, the handle and blade attachment portion are formed of a lightweight material in a well-known manner, for example, by using injection-molded plastic. In the preferred embodiment, the handle is hollow and has a aesthetically and ergonomically pleasing shape.

FIG. 3 illustrates how the blade attachment portion 20 is integrated with the handle 10. FIG. 4 provides additional detail regarding the inclusion of a razor blade 22 in the blade attachment portion 20. In the preferred construction, the blade attachment portion 20 includes five sections 20a-20e which are organized in a fan-like arrangement and then molded together. Thus, portions 20a and 20e overlap portions 20b and 20d, respectively. Likewise, the rear portion 20c also overlaps portions 20b and 20d. The inside lip of each portion includes a recess 24 (dashed line) to securely accommodate one or more blades. A machine inserts a steel blade portion 22 of the desired size into the recess. As noted above, the width of the steel razor blade be approximately one inch or less, and the dimensions of the blade attachment portion 20 will vary accordingly to accommodate a particular blade size. Once the blade is in place, the blade attachment portion is either snapped into a corresponding receptacle area on the handle, or fixed in place by heating/melting the pieces together.

It should be noted that two or more razor blades could be fitted into the recess on the blade attachment portion 20 to provide additional cutting edges.

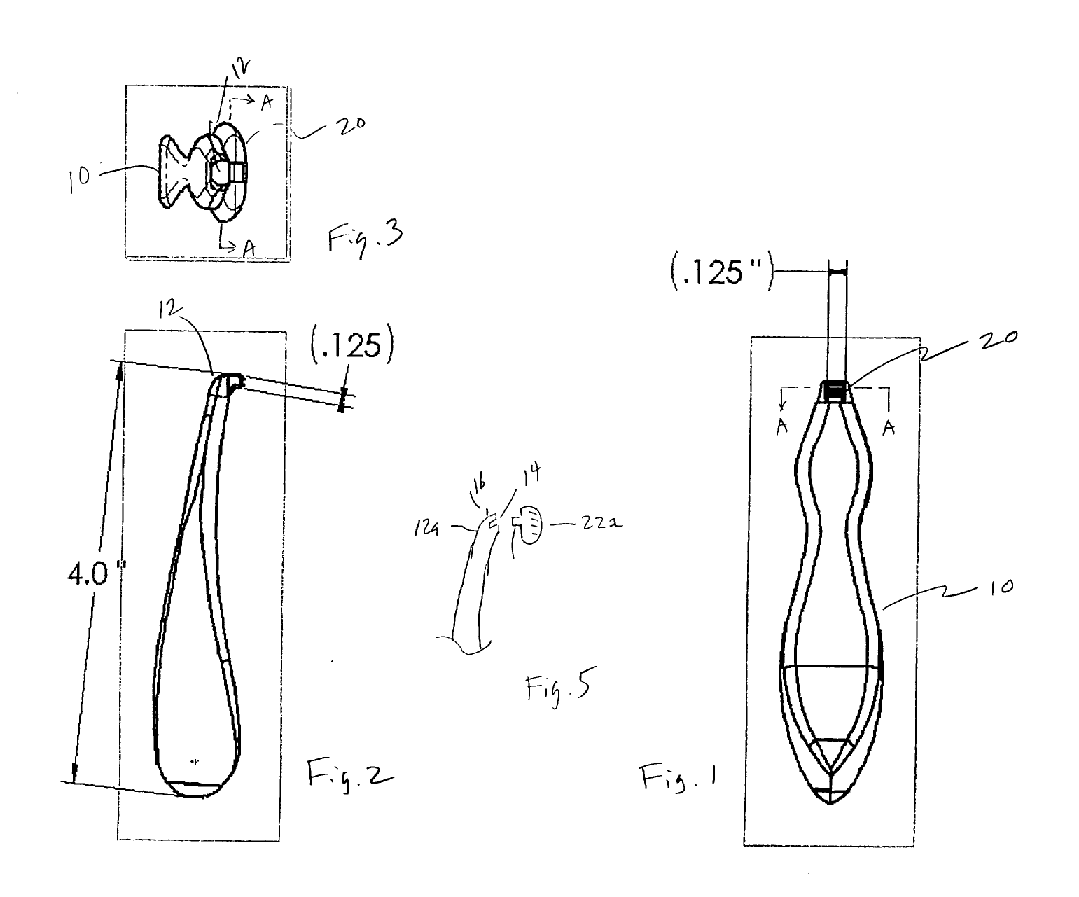

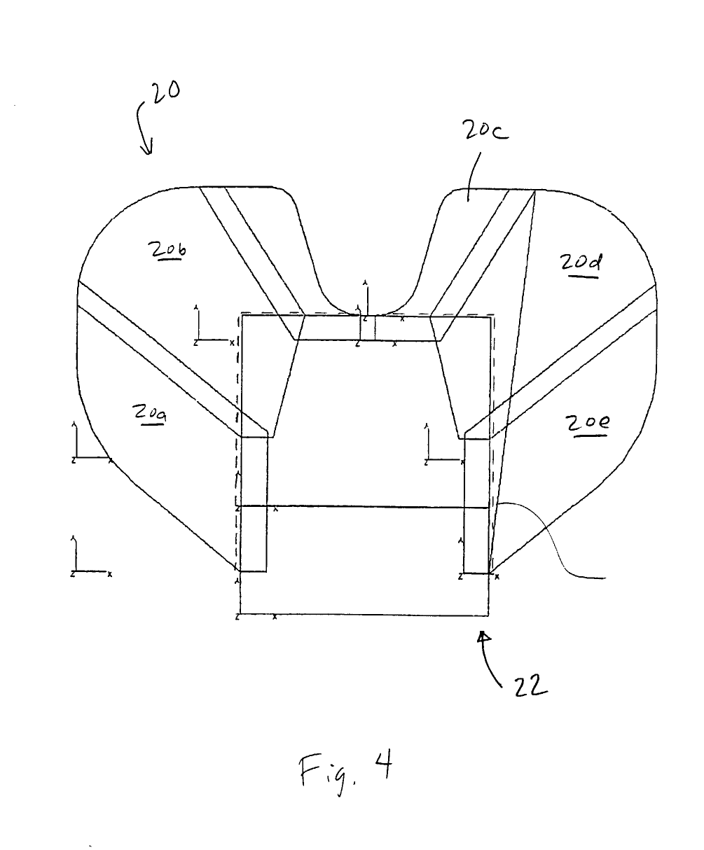

An alternative embodiment is shown in FIG. 5. In this embodiment, the angled head 12a includes a retention mechanism 14 which mates with a clip 22b on a replaceable blade cartridge 22a in a well known manner to secure the cartridge to the head 12a. The retention mechanism 14 includes a release 16 which is hand actuated to allow removal and replacement of the cartridge.

It should be understood that the invention is not intended to be limited by the specifics of the above-described embodiment, but rather defined by the accompanying claims.

I claim:

1. A personal styling razor, comprising a handle having a head portion and a razor blade integrally attached to the head portion, said razor blade having a width which is less than or equal to one inch.

2. A personal styling razor as in claim 1, wherein two razor blades in close parallel proximity are integrally attached to the head portion.

3. A personal styling razor as in claim 1, wherein multiple razor blades in close parallel proximity are integrally attached to the head portion.

4. A personal styling razor, comprising an integrally formed handle and a head portion, a retention mechanism affixed to an end of the head portion, and a cartridge removably coupled to the head portion via the retention mechanism, said cartridge including at least one razor blade integrally formed with the cartridge, wherein said razor blade has a width which is less than or equal to one inch.
